(19) United States
(12) Patent Application Publication
(10) Pub. No.: US 2012/0109952 A1
(43) Pub. Date: May 3, 2012

(54) SYSTEM, METHOD, AND COMPUTER PROGRAM FOR REMOTE MANAGEMENT OF DIGITAL CONTENT

(76) Inventor: Raymond Reddy, Mississauga (CA)

(21) Appl. No.: 13/003,899

(22) PCT Filed: Aug. 20, 2009
(86) PCT No.: PCT/CA2009/001175

§ 371 Date: Jan. 13, 2011

(30) Foreign Application Priority Data
Dec. 5, 2008 (US) 61120278

(51) Int. Cl. G06F 17/30

(52) U.S. Cl. 707/736; 707/E17.044

(57) ABSTRACT

The present invention is directed towards a data structure enabling data management capabilities on a second computing device, including for example a portable device, that are typically only available to users using data management applications provided on a first computing device, including for example a personal computer. The present invention also provides these management capabilities in association with content that does not necessarily need to be fully stored on the second computing device. The present invention further provides these capabilities with or without the presence of a network connection between the second computing device and a first computing device, which typically hosts the full set and full attributes of digital content.

### FIELD OF THE INVENTION

The present invention generally relates to management of digital content. The present invention more specifically relates to a data structure enabling the remote management of a collection of content from a plurality of applications with or without a network connection.

### BACKGROUND OF THE INVENTION

The amount of data that users store on their personal computers has grown exponentially as storage space and data bandwidth continue to increase. A trend known to most modern computer users is that as storage space and bandwidth increase, users store more data and higher quality (and hence larger) data items. Thus not only is the number of files or data items growing but the size of each file or data item is also growing. For example, users prefer to have higher quality media items such as songs and videos that take up more storage space than before. This is usually not a problem for users of relatively new personal computers due to their memory and storage capabilities, which is typically more than adequate for storing and enabling consumption of such data items.

On the other hand, the market for small, portable devices such as mobile phones and portable media devices (including MP3 players) is growing. Moreover, the border between traditional computers and these portable devices is becoming blurred, as more and more software unrelated to voice communication per se, such as network access and display applications, is being included with the devices.

Portable devices typically have less storage, memory resources and processing power compared to personal computers. Although storage and memory capacities are continually being increased with each new generation of portable device, users seek larger (higher quality) and more data files to store on these higher-capability devices. Due to these limitations, portable devices may not be able to store all the media content and associated data a user has on their personal computer, forcing a user to choose only a subset of their media content to be transferred to their portable device, offering reduced interactivity with their media collection on the portable device.

Many users have large collections of media items such as text, photos, music and video files on their personal computer. A user may manage and interact with such media items using media management applications, such as WINDOWS™ MEDIA™ PLAYER™ and APPLE™ iTUNES™, on a personal computer. The management and interaction with media items may include, for example, modifying attributes of media items or associating particular media items with media libraries. These media management applications may also allow a user to transfer certain media items to a portable device capable of playing back the media items.

The large collections of media items or media collections for some users may be too large to store on the user's portable device. Consequently, users are not afforded the opportunity to interact on the portable device in a responsive and user-friendly manner with media items or media items that have not been copied to the portable device. One disadvantage of this model is that the amount and quality of management and interaction a user has with their media items or media items on a portable device is typically limited compared to the management and interaction available using a personal computer.

In response to this shortcoming, some portable devices in the market have introduced the ability to operate remote applications to remotely access or stream content, not stored on the portable device, from a personal computer using a wireless network connection, similar to the functionality of a web browser. In this model, the user can interact on the portable device with media items or media collections that have not been copied to the portable device by using the portable device as a virtual interface to the personal computer. However, a disadvantage of this model is that the interactions on the portable device with the media items or media collections are only possible during periods that a wireless signal is available, which may not be the case in particular situations including in underground parking lots, airplanes or during network outages.

Therefore, what is required is a way to enable a user to manage and interact with media items and media collections on a portable device, regardless of the availability of the media content on the portable device, in a way that is comparable to the management and interaction possible on a personal computer. Particularly, this need must be met without the availability of a network connection.

### SUMMARY OF THE INVENTION

The present invention provides a system for remotely managing one or more data items, each data item including content and attributes, the system comprising: (a) a first computing device linked to a memory, the first computing device linked to a database including one or more content and one or more attributes related to each content, the first computing device operable to create a structure for referencing the content and attributes, the first computing device further operable to provide the structure, content, and attributes to a second computing device; and (b) the second computing device linked to a memory, the second computing device operable to receive the structure and a subset of the content and/or attributes from the first computing device, the second computing device operable to enable a user to interact with the structure so as to define one or more instructions to the first computing device for accessing or interacting with the content and/or attributes.

The present invention also provides a system for remotely managing one or more data items, the system comprising: (a) a first computing device, the first computing device linked to one or more content and one or more attributes associated with each content, wherein the first computing device is operable to enable modification of the content and/or attributes to define updates; (b) a second computing device remote from the first computing device, connectable to the first computing device via a network, the second computing device linked to a data structure including at least one of the one or more attributes for each content and referencing each content, the second computing device operable to enable modification of the content and attributes of the data structure to further define updates; and (c) a communication agent linked to the second computing device, wherein the communication agent is operable to detect a wired or wireless data connection to the first computing device and thereby initiate a transfer between the first computing device and the second computing device corresponding to a synchronization of the updates.

The present invention further provides a computer-implementable method for remotely managing one or more data items, each data item including content and attributes, the method comprising: (a) creating, or facilitating the creation, by one or more computer processors of at least a first computing device, a structure for referencing the content and attributes, the first computing device linked to a memory and linked to a database including one or more content and one or more attributes related to each content, the first computing device operable to enable the structure to reference the content and attributes, the first computing device further operable to provide the structure, content, and attributes to a second computing device; (b) linking the second computing device to the first computing device by wired or wireless means, the second computing device linked to a memory, the second computing device operable to receive the structure and a subset of the content and/or attributes from the first computing device, the second computing device operable to enable a user to interact with the structure so as to define one or more instructions to the first computing device for accessing or interacting with the content and/or attributes.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 illustrates a remote management system 100 in accordance with the present invention.

FIG. 2 illustrates a plurality of data layers stored in a typical media player application that operates on a first computing device.

FIG. 3 illustrates an example of a data table that stores playlist data for songs in a user's data collection and an index table that corresponds to a data table.

FIG. 4 illustrates an example of a database modify operation wherein the device database works in a distributed manner relying on a first computing device component.

FIG. 5 illustrates an example of the basic components of a second computing device operable to execute a remote application having computer executable instructions for accessing, modifying or otherwise making use of the optimized digital data structure and database system of the present invention.

FIG. 6 illustrates an example of an interface for a data management application for managing audio digital content. In this example, a plurality of playlists are displayed by the user interface of the data management application.

FIG. 7 illustrates a novel system operable with a content player that may be a component of a remote application.

FIG. 8 illustrates a wireless update process according to the present invention.

FIG. 9 illustrates the application gateway process 900 of the present invention.

FIG. 10 illustrates a process whereby the application gateway on a first computing device polls the device for changes.

### DETAILED DESCRIPTION OF THE INVENTION

### Overview

The present invention is directed to providing a system, method and computer program for managing from a remote second computing device one or more digital content that are linked to a first computing device. A persistent network connection need not be required between the first and second computing devices once the first and second computing devices are synchronized. An application gateway may optionally be provided on the first computing device and a communication agent may be provided on the second computing device for enabling a synchronization of digital content. The application gateway may not be required if an operating system executable on the first computing device is used for communication to the communication agent of the second computing device.

Without limiting the possible implementations of the present invention, it can be advantageously implemented where a disparity exists between the resources or attributes associated with the first computing device, and those associated with the second computing device, such that the second computing device has lesser or inferior resources in comparison to the first computing device. These resources or attributes may relate for example to memory, power, screen size, existence or quality of data connection, and may affect the ability to access or interact with content in its original form from the second computing device. An advantage of the present invention is that it enables a user of the second computing device to access and interact with data items or a data collection associated with the first computing device, from the second computing device, despite the limitations that may be presented by such lesser or inferior resources or attributes.

For example, the present invention provides data item and data collection management capabilities on a portable device that are typically only available to individuals using data management applications provided on a personal computer. The present invention also provides these management capabilities in association with data items and data collections that are not necessarily fully stored on the portable device. The present invention further provides these capabilities with or without the presence of a network connection between the portable device and a host personal computer, which typically hosts a full set and full attributes of data items and data collections.

Thus the present invention enables a user to access and interact with a large data collection via a second computing device, including for example a portable device, with or without a network connection, even when the data collection is larger than the storage capacity of the second computing device or when the entire data collection is for any reason not present on the remote computing device. The present invention accomplishes this using a novel methodology and novel hardware and software components. The result includes advancement in portable device (e.g. mobile phone) technology enabling portable devices to support management capabilities for various types of data items, including for example audio and video content encoded in a variety of formats.

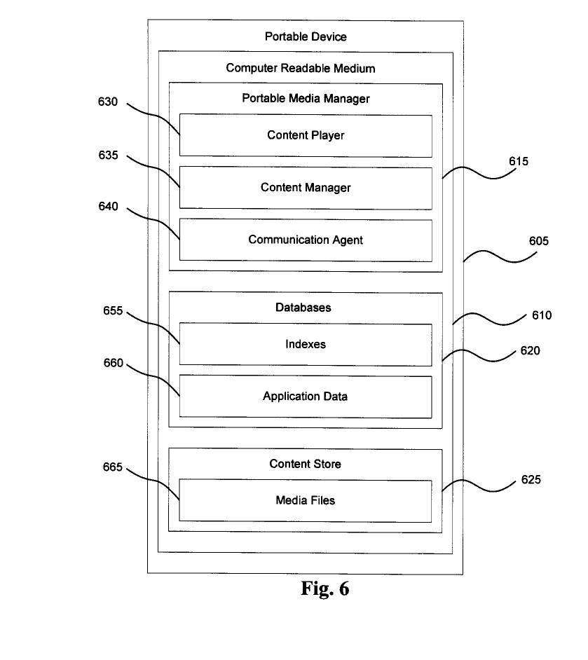

The novel methodology of the present invention enables a user to manage a data collection from the second computing device. The data collection comprises one or more data items. The novel methodology includes the use of an optimized digital data structure, a data management application, a communication agent, and optionally a content player and application gateway as shown in FIG. 6.

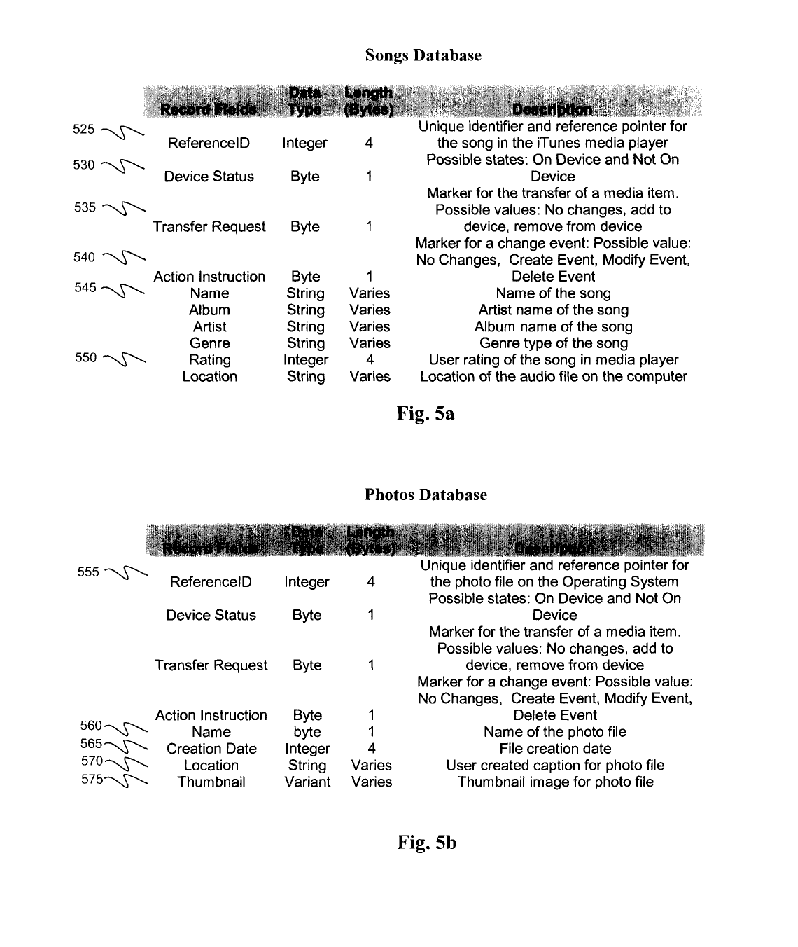

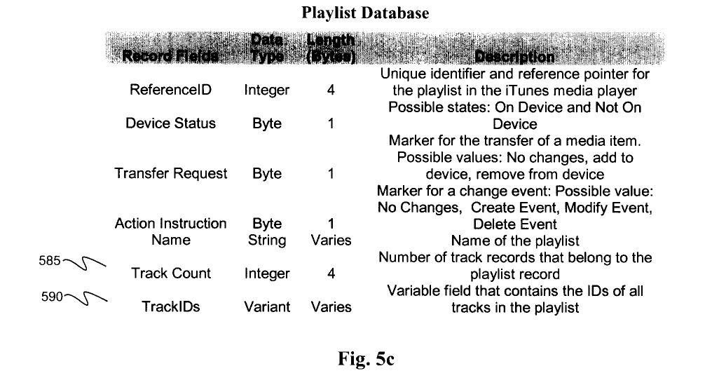

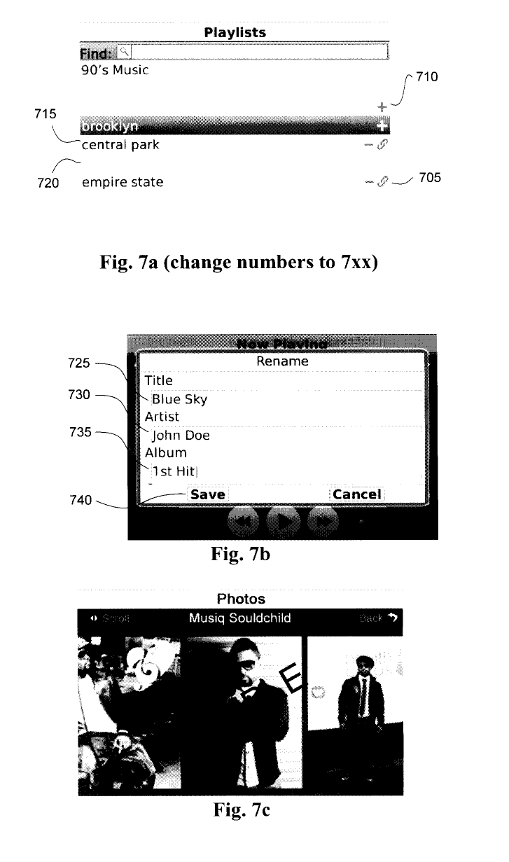

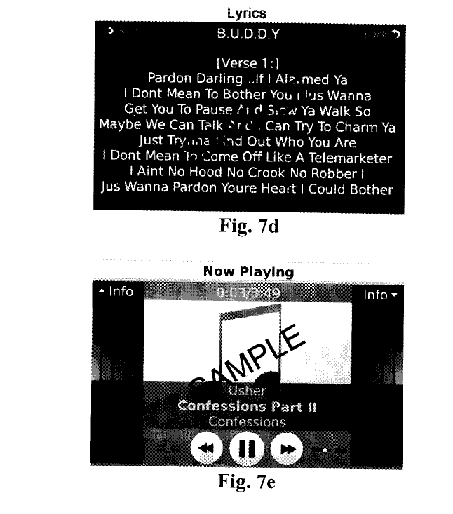

The optimized digital data structure may be implemented to a database as shown in FIG. 5. The data management application and content player shown in FIG. 7 are software applications on the second computing device that the user can use to manage and interact with the optimized digital data structure. The communication agent is used to communicate and transmit changes between the application gateway on the first computing device and the second computing device shown in Process 800 and Process 1000. The application gateway is software that runs on the first computing device that interfaces with applications on the first computing device and can also communicate with the communication agent on the second computing device. Operation of the application gateway is shown in Process 900.

The optimized digital data structure provides a structure to represent a data collection. The optimized digital data structure references all data items of the data collection, where each data item comprises content and one or more associated information or attributes. Typically, the storage size of the content is typically far greater than that of the attributes. The optimized digital data structure includes for each data item a reference to the content and includes for each data item the attributes, thus enabling relating a set of attributes to the content for each data item in the data collection. The reference to the content may be to a location of the content on a memory of the second computing device. By transferring to the second computing device only the set of attributes (or at least one attribute for each data item) provided by the optimized digital data structure, the second computing device may be able to represent to a user the entire data collection, whereas only a subset of the content, or no content, need be stored on the second computing device at any given time. The analysis of content and associated attributes may be provided on a first computing device, for example a personal computer, and then transferred to a second computing device, for example a portable device.

The optimized digital data structure may be implemented to a database. The database may be linked to each of the data items by including attributes and referencing content, for example with the use of a pointer to the location of the content on a memory. The optimized digital data structure enables a user to dynamically manage on the second computing device the data items. Each link from the database may correspond to one of the data items. The database may use tables which enable fast seek and read times. A user may manage their data collections using the database with certain modifications writing to the database. Writes to the database may be processed once a synchronization operation with the first computing device is underway, enabling the first computing device to modify the database. This promotes efficiency since the first computing device typically is computationally more powerful than the second computing device.

The data management application provided by the present invention enables a user to manage data items from the second computing device. More particularly, the data management application enables management of content and all or a subset of attributes associated with content by a user. The data management application could be considered an interface between the user and the database discussed above and in detail further below. The data management application may allow a user to create, modify, and delete content and their associated attributes.

The communication agent and application gateway provided by the present invention enable synchronization between the second computing device and the first computing device. The communication agent may be executed on the second computing device and application gateway may be executed on the first computing device such that they exchange information between the second computing device and the first computing device. The communication agent can function asynchronously or asynchronously and may be enabled to detect a connection between the second computing device and the first computing device. Using novel techniques, the communication agent enables synchronization to the first computing device of the data items and the data collection provided on the second computing device, or vice versa. The particular synchronization technique used could vary and may optimally be any bidirectional synchronization technique.

Finally, where appropriate, a content player may be provided optionally. The content player provides a novel interface using input means, such as buttons, commonly included with second computing devices. The novel interface may enable a user to take full advantage of the functions noted above and further described in detail below.

Thus the present invention provides a system, method and computer program enabling users to manage data collections that exist on the first computing device 105 from one or more second computing devices 120 by using the novel optimized digital data structure. For example, users may use the second computing device to manage a data collection on the first computing device even though the capacity, power and functional capabilities of the second computing device may be significantly inferior to that of the first computing device.

The present invention is particularly applicable where the second computing device is a portable device. Therefore, the present invention provides a system, method and computer program for mobile optimization of a user's entire data collection for transfer and use on a portable device with a storage capacity that typically would not be accommodate the entire data collection. The invention allows a user to interact with and manage data items or data collections on their portable device with or without a network connection.

### System Implementation

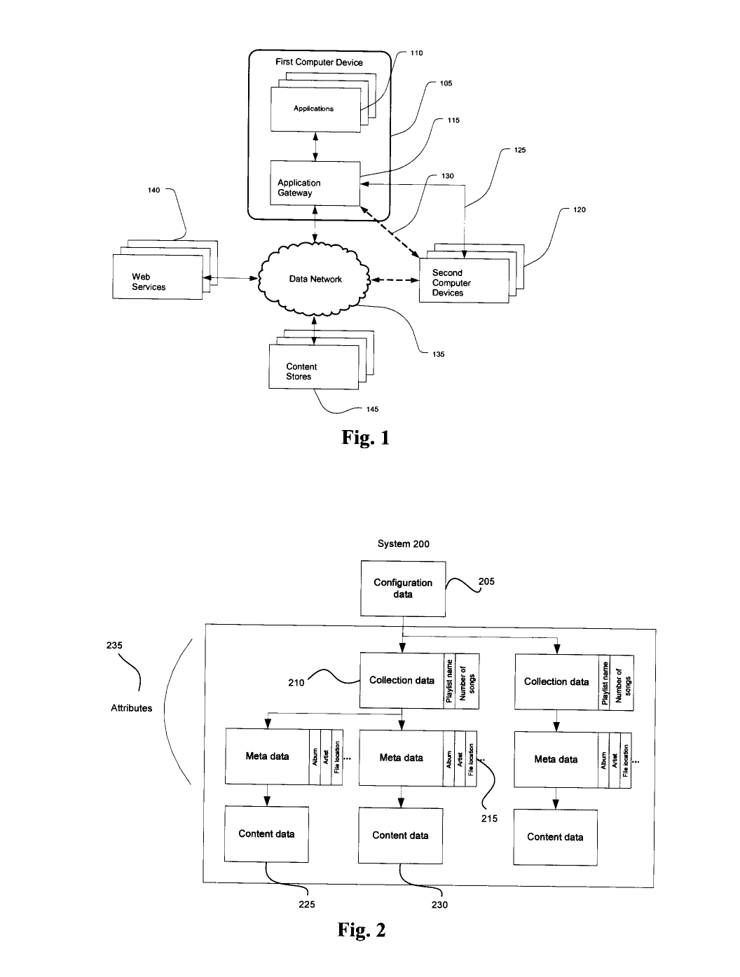

FIG. 1 illustrates a remote management system 100 in accordance with the present invention. The system 100 may include a first computing device 105 that has a number of interfaces including a wired connection 125 (for example, USB), short range wireless 130 (for example, Bluetooth) as well as wireless network connections (for example, 802.11, WiMAX, etc.). The system 100 may enable the collection of data items on the first computing device 105 and the transfer of data items between the first computing device 105 and the second computing devices 120 using wired 125 and/or wireless 130 links, including via a further network 135.

It should be noted that the second computing device may be a hand-held two-way wireless paging computer, a wirelessly enabled palm-top computer, a mobile telephone including one with data messaging capabilities, a portable digital media player, or a wirelessly enabled laptop computer, but could be any type of remote or mobile data communication device capable of exchanging data over a network connection. The second computing device may include a communication agent that works in conjunction with the first computing device and in particular with an application gateway or operating system of the first computing device device to enable the exchange of data items between the first and second computing devices.

It should further be noted that the first computing device may be a personal computer, laptop computer, local server, Internet server, a cluster of computers, or even another second computing device operable to store a collection of data items so long as the first computing device is a network connected device operable to exchange data with the second computing device. In summary, a person skilled in the art will appreciate that the systems and methods herein described are applicable to any system wherein a first computing device is operable to store a data collection and a second computing device is operable to store at least a subset of attributes associated with the data collection. Alternatively, a set of first computing devices may together store the data collection, so long as the entire data collection is represented across the computing devices of the system.

The collection of data on first computing device 105 can pertain to data stored and used by applications 110 on the first computing device 105. System 100 may also enable the configuration of applications 110 on the first computing device 105 from the second computing devices 120 over wired or wireless connections 125, 130, or through network 135.

The first computing device 105 may be operable to execute one or more applications 110 used to manage data items or data collections. The first computing device 105 may operate an application gateway 115, a software application which provides an interface between applications 110 operating on the first computing device 105 and second computing devices 120. The application gateway 115 may read data from and modify or add data to each application 110 it communicates with via supported interfaces such as Application Programming Interfaces (APIs). The APIs may enable applications on the second computing devices 120 to access and modify data. Application gateway 115 may also interface with remote web services 140 and third party content stores 145 that may provide extended information to the data items referenced by the applications 110 using a request/response process. For example, if the data management applications 110 are media management applications for managing and playing media items, for example music, the web services 140 may provide lyrics or artist biographies for each song in the media collection and the content stores 145 may be online music stores providing access to new music.

A plurality of second computing devices 120 may communicate with application gateway 115 on first computing device 105 over a wired connection 125 (such as a USB cable or IEEE 1394/Firewire interface), a wireless connection 130 (such as TCP/IP 802.11 or Bluetooth), via network 135 whether wired or wireless (such as GPRS, CDMA or other cellular data transmission networks), or any other computer-to-computer transmission protocols. The protocol used may be any protocol supported by the particular second computing device 120 on which the remote application operates.

### Optimized Digital Data Structure

There is a variety of types of data items that can be delivered, downloaded, accessed, modified and/or otherwise made use of on data management applications on both the first and second computing devices, including for example pictures, audio, videos, documents and data records for customer relationship management applications.

The optimized digital data structure is a structure optimized for the second computing device, where the optimized digital data structure is based on the types of attributes and content of the data items on the first computing device, and defined to enable, from the second remote computing device, access to or interaction with these data items, despite possible limitations of the second computing device referred to above.

The advantage provided by the optimized digital data structure is to enable a user, using a second computing device, to refer back to the content or specific parts or attributes associated with the content, located on the first computing device, in a way that enables specific access to the content from the second computing device. This enables, for example, modification of attributes related to the content from the second computing devices, as illustrated below, even if the content itself is not located on the second computing device.

A user, from the second computing device, can interact with data items referenced by the optimized digital data structure, enabling the creation of instructions for accessing or interacting with the content, even when the second computing device is not connected to a network, so that there may not be any connection to the content on the first computing device. These instructions may be stored and then sent to the first computing device, or accessed by the first computing device, once the connection to the network is restored, thereby effectively permitting the user of the second computing device to initiate access to or interaction with the content when the second computing device is not connected to the network.

The optimized digital data structure may be defined for a second computing device by a first computing device or each second computing device could contain a definition for the structure it wants a first computing device to create and provide. The definition may be stored in a file and may detail the number and types of attributes required by the second computing device to interoperate with the optimized digital data structure. One advantage of the present invention is that the use of the optimized digital data structures to represent a user's data collection typically requires much less storage (and/or memory) space than would storage of the entire data collection. Consequently, a second computing device, having a storage capacity less than required to store the user's entire data collection, still provides all the benefits and features typically only enabled by having the entire data collection available on the second computing device. In this way a user may interact with and manage their data collection on a second computing device in the same way as they would on a first computing device even though not all the content is required to be present on the second computing device.

### Examples of Optimized Digital Data Structures

In one particular example of the optimized digital data structure, it is optimized for use with a data collection that is a media collection. The data management application is a media management application, in this example. It should be understood that the optimized digital data structure could be optimized for any other type of data collection, as is applicable in a particular implementation.

FIG. 2 illustrates a plurality of data layers stored in a typical media management application operable on a first computing device. The data layers may comprise the content 225, 230 and various attributes describing the content, including metadata 215, 220, collection data 210 and configuration data 205 in this example.

Content 225, 230 includes data that can pertain to audio, video, text and/or images for consumption by a user. Some examples of specific forms of content 225, 230 include, but are not limited to, songs, audiobooks, advertising, movies, television shows, music videos, photos, computer games, audio and/or video clips or presentations, news reports, sports updates, and podcasts. In the present example, content 225, 230 are audio data such as songs or podcasts.

Metadata 215, 220 describes content 225, 230 respectively. In the present example of audio media items, metadata 215, 220 could include the song title, album, artist, genre, user ratings and file location which acts as a pointer to the content 225, 230. In the case of a photo, metadata 215, 220 may include the album, date it was taken and user captions for the photo. In the case of a TV show, metadata 225, 230 may include the name, season, and episode number, amongst other things.

Collection data 210 is data describing a set of data items in a data collection. Collection data 210 can define a collection based on identical metadata 215, 220 such as a collection of songs from the same album or artist, photos taken from the same vacation or user defined collections including a playlist of favourite songs or a slideshow of a child's pictures.

Configuration data 205 is data that describes user preferences and settings within a media management application, for example relating to the management and consumption of media items. Configuration data 205 could include the currently playing media item, volume settings and other user configurations or preferences. Certain types of configuration data 205 may be proprietary to certain media management applications and others kinds might be shared across common media management applications.

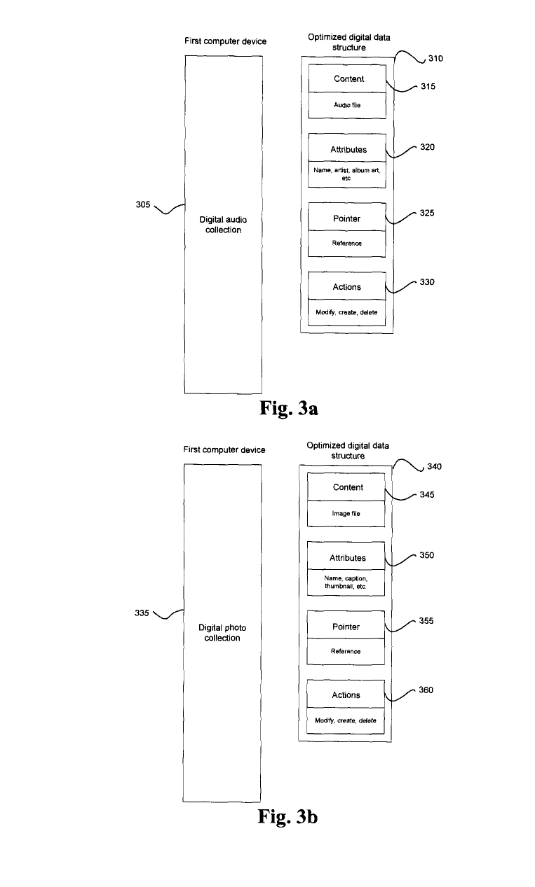

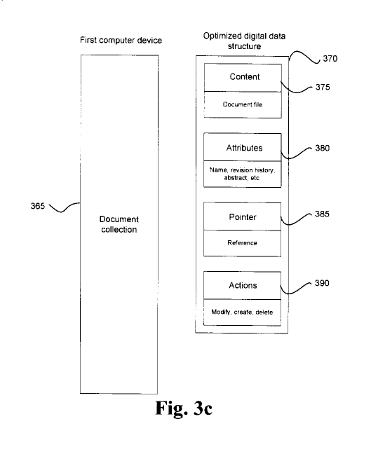

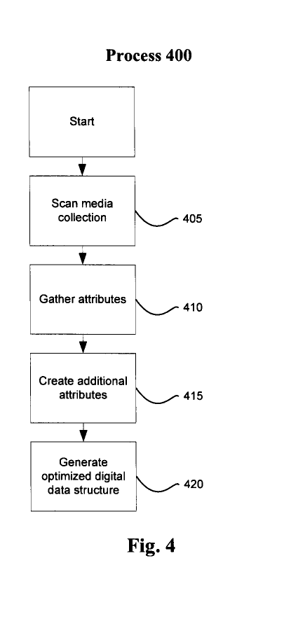

In one example, the media collection stored on a user's first computing device may be analyzed based on the data layers illustrated in FIG. 2 to generate the optimized digital data structure 310 shown in FIG. 3a. One aspect of the optimized digital data structure includes attributes 320 for each media item in the media collection 305 on the first computing device. The attributes 320 correspond to the attributes 235 shown in FIG. 2 and may be further broken up into metadata 215, collection data 210 and configuration data 205. The optimized digital data structure stores, in one implementation, a reference pointer 325 for the content of each media item 305. The optimized digital data structure may optionally store action instructions 330 for any changes made from the second computing device so that such changes can be applied to the media items 305 on the first computing device. The optimized digital data structure optionally contains a subset 315 of the content 305 from the first computing device.

One advantage of the optimized digital data structure is that it enables a representation of a data collection on the second computing device to occupy a small fraction of the space of the entire data collection on the first computing device. When used on a second computing device 120, a user may thus interact with all data items in a manner similar to the interaction of content on a first computing device 105, which can have significantly more storage capacity. For example, in the content of media items that are audio, a user may create a playlist of songs where the content corresponding to the media items is not present on the second computing device 120, which is a capability not typically possible on the second computing device 120. A user may also edit attributes for content not present on the second computing device 120, such as song name, artist, album, etc. The user may also manually manage content 225, 230 by selectively choosing a subset of content 225, 230 to be transferred or removed from the device or such transfer or removal of content 225, 230 may be automated based on preferences, rules or policies depending on the amount of storage space available on the second computing device. Modifications or actions to data items, in accordance with the optimized digital data structure, may be transmitted to the first computing device 110 from time-to time (using a variety of methods) via the application gateway 115.

Furthermore, the optimized digital data structure may also include representing content on the first computing device with new content to be made accessible on the second computing device. The new content is a representation of the original content, the representation being linked to the structure of the original content such that the representation enables access to or interaction with the original content from the second remote computing device, again despite the limitations of the second computing device. The image and document examples below illustrate this type of optimized digital data structure.

In another example, the data collection is an image collection, including photographs. The optimized digital data structure is optimized for use with the image collection. The data management application is an image management application, in this example. Again, it should be understood that the optimized digital data structure could be optimized for any other type of data collection, as is applicable in a particular implementation.

The optimized digital content structure 340 shown in FIG. 3b includes attributes 350 for each image item in the image collection 335 on the first computing device. However since these attributes 350 may not be sufficient for a user to identify the image items without the content, “thumbnail images” (smaller, reduced quality images representing the original content) may be created from the original content and added as an attribute 350 for each image item, making it easier for users to identify image items without having all the content 335 present in the optimized digital data structure 340. The optimized digital data structure again includes reference pointers back 355 to the content of each image item in the image collection 335. The optimized digital data structure 340 optionally stores action instructions 360 for changes made and may contain a subset 345 of image items from the image collection 335 depending on the capacity of the second computing device that will store and use the instance.

In a further example, the data collection is a document collection. The optimized digital data structure is optimized for use with the document collection. The data management application is a document management application, in this example. Again, it should be understood that the optimized digital data structure could be optimized for any other type of data collection, as is applicable in a particular implementation.

FIG. 3c shows an optimized digital data structure 370 created for a document collection 365 stored on the first computing device. Since document attributes 235 such as the name alone may not be helpful to a user in identifying the document items without the content, a summary or abstract (representing the original content) may be added to the attributes 380 for each document item in the document collection 365. An abstract may be automatically created if it does not exist within the document using a variety of existing data management applications including, for example, word processing applications. The optimized digital data structure 370 includes reference pointers 385 to the content of each document item in the document collection 370 on the first computing device. The optimized digital data structure 370 optionally stores action instructions 390 for changes made and may contain a subset 375 of the document items from the document collection 365 depending on the capacity of the second computer that will store and use the document item.

This set of data items, structured using the optimized digital data structures, may then be used to manage from the second computing device all documents, audio files and images residing on the first computing device whether or not all of the corresponding content tem is present on the second computing device. The data items may also be used by a user on the second computing device to transfer or move content between the second computing device and the first computing device, enabling the first computing device to act as a content repository.

### Storage of the Optimized Digital Data Structure on the Second Computing Device

Each data item structured using the optimized digital data structure may be generated using process 400 and then transferred to the second computing device. Process 400 takes in as input the location of the data collection and the attributes required. Even though all data files may be stored on and are accessible by the file system of the first computing device, in some cases an additional data management application, that may include additional attributes unique to the data management application, may be used by the user to manage the data collection. For example typical media management applications for music may store and present a “user rating” and “played count” for each song in addition to standard song attributes, and typical image management applications may allow users to create and edit captions for each picture.

Process 400 begins by scanning 405 the data collection. This is done by either enumerating the files on the file system or by accessing the data management application used to manage the data collection depending on the user's preference for each type of data collection. Many data management applications publish and maintain an Application Programming Interface (API) that allows external applications and processes, such as Process 400, to access the data items and associated attributes within the data management application. Process 400 gathers attributes 410 (including metadata 215, collection data 210 and configuration data 205) for all data items on the first computing device, regardless of whether the content for the data items is to be transferred to the second computing device. Process 400 may create additional attributes 415 from the content or attributes of the data items based on the data type and as required by the second computing device, for example creating thumbnail pictures in FIG. 3b or document summaries in FIG. 3c. Process 400 then generates the data item, structuring using the optimized digital data structure 420, that can be transferred and used on the second computing device. Process 400 can be run by a data management application on the first computing device, such as the application gateway 115.

One particular example of a data structure that can be used to implement and store the data items is a database. FIGS. 5a, 5b and 5c are example of database tables that are used for an optimized digital data structure. The table definitions contain the necessary field names, data types and field descriptions for those skilled in the art to readily implement the invention in a standard relational database. FIG. 5a illustrates an example table definition for an optimized digital data structure for referencing media items of a user's media collection of audio. In this example the media items are stored in a media manager application on the first computing device so the content and associated attributes are accessible through standard Application Programming Interface provided by said the media manager application. ReferenceID 525 contains a pointer to the media item within the media manager application, which could be a unique persistent identifier used to access the content and attributes. Device Status 530 indicates if the content is presently on the second computing device or not and Transfer Request 535 stores a user request to move the content to or off the second computing device. Fields 530 and 535 manage the state and transfer of the content to and from the second computing device from the first computing device as shown in FIG. 7a.

The set of other attributes 545 such as the song name, album, genre, artist, song rating and file location are stored in each record. Those skilled in the art will understand that the database herein described is extensible to include other attributes, for example song lyrics or artist biographies. Any changes made by the user to attributes are tracked using the Action Instruction field 540 as shown in FIG. 7b. Such change instructions may be transferred back to the first computing device or polled by the first computing device as shown in Process 800 or Process 1000 respectively. Although the Action Instruction field 540 is not required, it allows changes to be transmitted to the first computing device without comparing all data items on the second computing device with all data items on the first computing device. The Action Instruction field 540 can significantly reduce the amount of data transferred from the second computing device to the first computing device, which may be particularly advantageous over a wireless connection.

FIG. 5b illustrates an example table definition for an optimized digital data structure for image items in a user's image collection. In this case the image items may be managed by the user directly on the file system and not in an image management application on the first computing device. The ReferenceID 550 in this case may be a unique pointer to the file on the file system. The attribute fields 560 stored in this case may be Name, Creation Date and Location which are gathered from the file system. Process 400 creates an additional attribute, Thumbnail 565, using the content to aid the user in identifying the image when using the second computing device if the original content is not present on the second computing device. The table contains the set of required fields 555 Device Status, Transfer Request and Action Instruction that serve the same functions as the database table in FIG. 5a so that the user may edit attributes and request content to be added or removed from the second computing device as shown in FIG. 7a and FIG. 7b.

FIG. 5c illustrates an example table definition for an optimized digital data structure created for a playlist of media items that are audio for using by a media management application on the first computing device. The table could be generated together with the table shown in FIG. 5a using Process 400. The playlist attributes include Name 590 for the name of the playlist and the set of fields 595 Track Count and TrackIDs that store the number of data items in the playlist and unique identifiers for each data item, respectively. The unique identifiers stored in TrackIDs 595 may relate back to ReferenceID 525 from FIG. 5a. A user may interact with the data items on the second computing device and edit the playlist by adding or removing data items from the playlist, which would be tracked using the Action Instruction 585 field. The Device Status 575 and Transfer Request 580 fields can be used to transfer playlists between the second computing device and the first computing device as shown in FIG. 7a.

In some cases a user may acquire or create new content on the second computing device, for example purchasing a new song, creating a new playlist or taking a picture using the second computing device. The optimized digital data structure could manage this content by setting the Action Instruction field as a ‘Create Event’ and the ReferenceID as empty and invalid (since the content does not exist on the first computing device yet). During Process 800 or Process 1000 this new content is transferred back to the first computing device and data items may be added by the data management applications on the first computing device (if used by the user). At this point ReferenceIDs can be set appropriately for the newly acquired/created media items or playlists.

### Use of a Content Store

FIG. 6 illustrates an example of the basic hardware and software components of a second computing device operable to execute a remote application having computer executable instructions for accessing, modifying or otherwise making use of the optimized digital data structure and database of the present invention. The second computing device 605 includes a memory, for example a computer readable medium such as content store 625 that stores individual data items (usually as files 665) and a database 620 that stores the optimized digital content structure.

The remote application 615 may include data management application 635, content player 630, content agent 640 and a user interface for displaying information and allowing a user to interact with their data collection. The second computing device may store and execute the remote application.

Data management application 635 may provide management capabilities for data items on the second computing device. For example, if the content is audio, the features may be similar to that of a desktop media manager and may include creating, modifying and viewing playlists of songs, modifying/editing ID3 tags/metadata, transferring or removing song content from the second computing device, etc. Other features may also be provided.

The content player 630 may interface with the database 620 and the content store 625 to access data items for purposes of rendering content. For example, the content player 630 may display images in the case of photographic digital content shown in FIG. 7c or display textual content shown in FIG. 7d, or play back audio or video content encoded in a number of different formats as shown in FIG. 7e. The content player's 630 ability to render content may depend on the capabilities of the second computing device on which it operates. Content player 630 combined with data management application 635, as shown in FIG. 7, provides a seamless user interface on the second computing device for interaction with and management of data items structured using the optimized digital data structure.

### Communication Agent

The communication agent 640 may interface the remote application 615 with the application gateway 115. The communication agent 640 may communicate with the application gateway 115 over a wired or wireless connection or a network connection from time-to-time as available. The communication agent may be decoupled from the content management and playback capabilities of the remote application and may interface with the database and content stores independently. The communication agent may detect and maintain a connection with the application gateway to stream changes made to data items on the second computing device back to the application gateway, as described more fully below. Alternatively, the application gateway may perform a process to synchronize data items and data management applications between the first computing device and the remote application as described more fully below. The communication agent 640 is more fully described below.

### Data Management Application

The data management application 635 shown enables interaction between a user and the content and attributes on the second computing device in a similar manner to that with a data management application on a first computing device, even though all the content from the first computing device may not be present on the second computing device. The data management application may allow a user to create, modify and delete content and attributes of each data item. At a minimum, the data management application may allow the user to modify the data items to enable content to be transferred between the second computing device and the first computing device.

FIG. 7 illustrates an example of an interface for a data management application for managing a data collection of digital audio items. In this example, a plurality of playlists is displayed by the user interface of the data management application. FIG. 7a illustrates a data management application interface 700 that may be used to manage the transfer and removal of the playlists. The data management application may use visual cues to distinguish between media items that are present on the second computing device, such as playlist 715 and playlist 720 that is grayed out because the content in that playlist is not on the second computing device. In FIG. 5c this is represented in the optimized digital data structure using the Device Status field for each playlist record that would be set accordingly. The user may then select to transfer playlist 720 to the second computing device by toggling selection of the playlist, which is indicated by visual element 710, so that the playlist is marked for transfer the next time a connection to the first computing device is available. If a connection is present, the content may be transferred immediately and accessed by the user either as the content is streamed or transferred in whole part to the second computing device. Similarly, the data management application may allow a user to remove playlist 715 from the second computing device by toggling selection of the playlist, which is indicated by visual cue 705. The content within playlist 715 may be removed from the second computing device immediately or left on the second computing device until more storage space is needed for new digital content at which point it may be deleted. Requests by the user to add or remove playlists would result in the Transfer Request field in FIG. 5c being set accordingly in the optimized digital data structure. In other cases content transfer and removal may be automated based on user preferences, policies or history of use. For example content relating to advertising (in image or video form, for example) may be automatically marked for removal from the second computing device based on the number of views tracked, and requests may be made for new advertising content. In this case, algorithms may be used to determine advertising content most relevant to the content on a user's second computing device for transfer to the second computing device. In other cases, the data management application may provide further management abilities such as the ability to edit content, such as documents, or attributes, such as metadata.

FIG. 7b illustrates a data management application interface 750 for modifying attributes. Due to the optimized digital data structure, a user may perform such modifications to attributes regardless of whether or not the content is present on the second computing device. For example, where the content is audio, the user may modify attributes including the song title 755, artist name 760, album 755 and other fields. When the user saves their modifications by selecting 770, the attribute fields (for example those shown in FIG. 5a) are updated and the Action Instruction field 540 is marked as ‘Modified’. The changes may then be transmitted to or synchronized with the first computing device by the communication agent when a wired or wireless connection is available as shown in Process 800 or Process 1000.

### Content Player

FIGS. 7c, 7d and 7e illustrate aspects of a content player 630 that may be a component of or separate from a media management application on the second computing device. The content player 630 may interface with the data items and may access data items from content store 625 and database 620 to render content and attributes. FIG. 7c illustrates an example of a content player rendering image content, FIG. 7d illustrates an example of a content player rendering textual content and FIG. 7e illustrates an example of a content player playing back an audio file.

### Communication Agent and Application Gateway

The communication agent and application gateway provided by the present invention enable changes made to the data items on the second computing device to be transmitted the first computing device as well as changes made to the data items on the first computing device to be updated in the data items on the second computing device. The communication agent may be executed on the second computing device and application gateway may be executed on the first computing device such that they exchange information between the second computing device and the first computing device. The communication agent can function asynchronously or synchronously and may be enabled to detect a connection between the second computing device and the first computing device. The particular transmission technique used could vary and may optimally be a bidirectional technique. One example of a transmission process is provided herein.

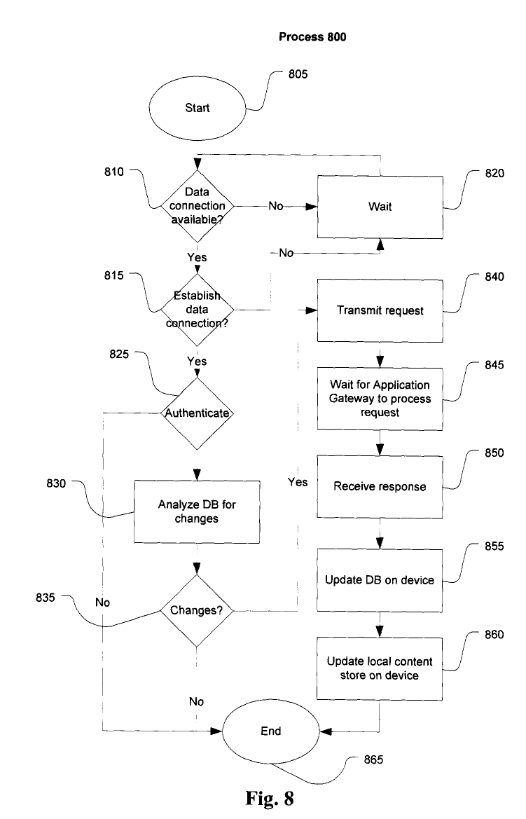

FIG. 8 illustrates a wireless update process according to the present invention. During the update process, changes made to content or attributes on the second computing device may be transmitted in real-time or from time-to-time to the application gateway on the first computing device.

The wireless update process may be performed by the communication agent 640 on the second computing device. The process may function independently by transmitting changes in the database to the application gateway over a wireless connection when available. The decoupling of the communication agent from the data management application operations such as database update process 600 may enable the data management application to operate asynchronously regardless of the presence of a connection. The communication agent may initiate the update process periodically or by notification from other processes of pending changes, such as the change made to a track record in FIG. 7b. These notification mechanisms can result in immediate processing of pending requests when required. The communication agent may be any wireless communication medium such as a short range wireless connection, a network wireless connection including a cellular data connection, or even a SMS gateway that sends messages in the SMS text body.

The wireless update process may be initialized 805 and a determination 810 may be made whether a data connection is available to the second computing device. The data connection may be any wireless network that facilitates the second computing device in acquiring data communication with the application gateway. When a determination 810 is made that the network is not available, a delay or wait 820 (also commonly called a “sleep”) can be imposed. Such a delay 820 may enable further processing prior to another determination 810 of whether or not a network is available.

When a determination 810 is made that a network is available to a second computing device, a further determination 815 is made whether a connection can be made to the associated application gateway. There are instances where the application gateway may not be available for various reasons (such as when the first computing device is powered off) and when this is the case, another delay 820 may be imposed and wireless update process 800 may restart. When a determination is made that a connection to the associated application gateway is available 815, an authentication process may be performed 825. This may be a simple exchange of identifier keys previously assigned or a more complex authentication scheme. If authentication 825 fails for any reason, the wireless update process may end.

When authentication 825 is successful the database on the second computing device may be scanned 830 for actions. As previously described, modifications or additions to the database requiring instructions to be transmitted back to the application gateway on the first computing device may be tracked by the Action Instruction field shown in the table definition in FIG. 5. If it is determined 835 there are no changes the wireless update process may end 865.

On the other hand, when a determination 835 is made that there are actions to transmit, the actions may be assembled into action requests that are transmitted 840 to the application gateway and the process then waits for a response 845 from the application gateway. If there is more than one action to be transmitted, each may be transmitted 840 consecutively until all actions are sent. The wait period may be asynchronous so that the data management application may perform other tasks while waiting for the response or synchronous such that the data management application is blocked from performing tasks until a response is received. During the wait period, the application gateway may process configuration changes and action requests from the communication agent, as is further described below in process 900.

The process 800 may receive one or more responses 850 from the application gateway to the one or more requests 840 previously sent. The responses may be confirmations that the respective action instructions were successfully processed by the application gateway or that the action instruction failed. For example, a new playlist created on the second computing device may be transmitted to the application gateway for creation on the first computing device. The response may also return other kinds of data. For example, if the request was for the transfer of content to the second computing device, the response may include the content. In another example, the request may be for attributes relating to data items that have been updated on the second computing device. Regardless of the particular response, it may be processed and stored.

Thereafter, the second computing device may update the device database 855. The updates may be dependent on the response received for the request. If the response indicated failure of the action, then the database may not updated so that the action remains pending and may be included in a subsequent request. If the response indicated that the change was processed successfully, then the database may be updated to clear the field marker used for marking record changes. In one example, where the request is for content, the response may include the content and the second computing device's database may be modified to represent that the content is now present on the second computing device.

The second computing device content store may then be updated 860. Updates to the content store may be dependent on the response. For example requests for configuration changes to a data management application on the first computing device may result in a success or failed response that may not result in any updates to the second computing device content store. Requests for content may result in responses containing the content, which may then be added to the second computing device content store 860, following which the process may end 865.

Although this example describes a process where requests are sent individually for each change, in another embodiment the process could “batch” requests. In this implementation, a single request may be sent for a group of changes and a response received for the request detailing the success, failure or returned data for each change within a request. One method for implementing a request/response system to handle multiple requests/responses is to embed a unique identifier in each request sent by the second computing device, whether independently or as a group, which is stored by the second computing device. The application gateway may extract the unique identifier from the request and include the identifier in each corresponding response. In this manner the application gateway may optimize request processing and process requests out of order and the device can still associate each response from the application gateway with the appropriate request.

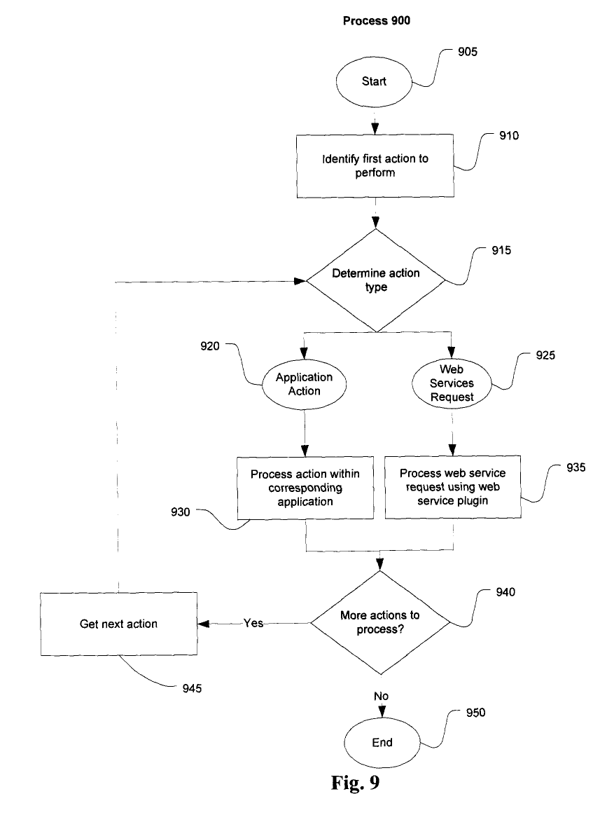

FIG. 9 illustrates the application gateway process 900 of the present invention. The process 900 may execute during the wait block 845 described above. The process 900 may initially determine one or more action instructions either marked by the device database or transmitted by the communication agent. A determination 915 may be made regarding the type pertaining to each action that requires processing. Actions types may be determined by pre-defined policies and be modifiable by the user. In this example, action types may pertain to either first computing data management application requests or web service requests and each action may be managed appropriately by the application gateway. Although the example illustrated in FIG. 9 shows a decision between only two action types, there may be many variations of action types and even nested action types such as parent-child action type.

One example of a set of application actions 920 that may be wirelessly transmitted by the communication agent may include configuration changes made on the second computing device to data items, such as adding new songs to a playlist or removing photos from a photo album. The application gateway may process such changes 930 by modifying the corresponding first computing device's data management applications that manage the content on the first computing device, as necessary. The changes may be synchronized during a synchronization process 1000 or performed on an action by action basis as they are transmitted during the process 800 previously described. The synchronization of these types of changes may be performed by any of a number of techniques known to those skilled in the art.

Another example relating to the first computing device's data management application actions 920 may be actions for performing content rendering on the first computing device instead of on the second computing device. In this example, a transmitted action from the communication agent may result in the application gateway performing playback of a song on the first computing device's data management application when the application gateway processed said action 930 within the corresponding first computing device's data management application. Similarly, this may apply to other digital content types such as photos, videos, documents and textual content. This is provided that the first computing device's data management application supports an API or other methods of programmatically performing playback or rendering actions by an external application. In this way a portable phone can act as a remote control to wirelessly remotely control a first computing device's data management application. Further, a user may combine configuration changes to data items so that a user may create a playlist of songs on the second computing device and then select to playback the playlist on the first computing device, which results in the playlist being configured in the corresponding first computing device's data management application and then played back. This experience represents an advanced remote configuration example which combines remote management of content and remote control capability from a second computing device.

In another example, the action request may represent a web services request 925. The web services request may be for downloading extended data (for example, additional attributes) for content in a data collection. Examples of extended data, in the case of media items that are audio, include artist biographies and song lyrics. The action may be processed by the application gateway 935 by making requests to a web services component (for example, by using http requests) 140, which may be able to store and return the extended data for some or all of the content in the data collection.

The action request made by the user on a second computing device may be for their entire data collection (including for data items that do not have content on the second computing device) or a selected subset of the data collection. Although the actions may be transmitted over a wireless network, in certain instances the application gateway may not be able to transmit action requests back in a response over a wireless network. This may be the case if the action request or corresponding response is too large or bandwidth charges are too expensive to send over a wireless network. In this case a second computing device can request a first computing device to “pre-fetch” extended data over a wireless network which may reduce the amount of transmission time when a wired connection is made between the first and second computing devices. In other instances, the application gateway may be able to respond back with action requests over the wireless network. In this manner the second computing device may be able to use the first computing device as a proxy to perform tasks on its behalf, such as aggregating action requests, and deliver results back over a wireless network or store the results until the next wired connection is made. Other action requests include requests for third party content such as new music or other advertising content that may be processed in a similar manner.

Following determination of the type of action to be taken 920, 925 the process 900 may process the action requests 930, 935. A determination 940 may then be made whether there are further action requests to process. If there are further actions requests, the next action requests may be retrieved 945 and each action request may be processed. If there are no more updates to process the process 900 may end 950.

In another example, the action request type determined 915 may be for a request for third party content. Such content can, for example, include purchasing new songs or albums of songs from a web service such as an online music store whether web based or application driven. The interaction with such stores may be made using APIs to programmatically purchase content. In another example, the action requests may require the first computing device to record video content using stream capture software from a website that displays the video content for viewing. Such content may be transferred onto the second computing device over a wired or wireless connection, enabling personal video recording capability on the second computing device.

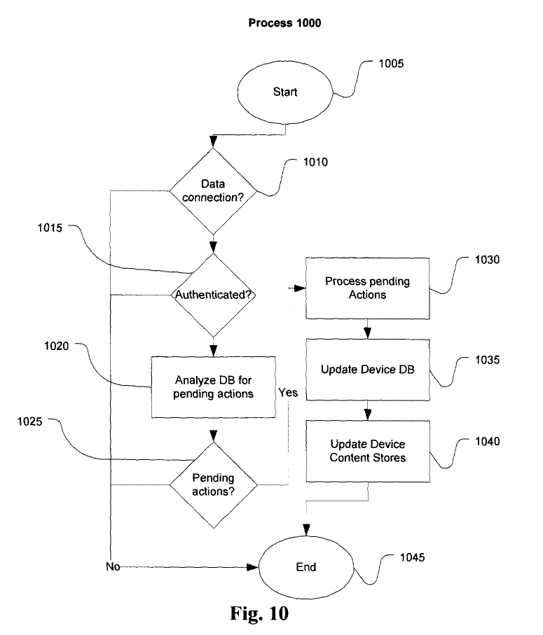

FIG. 10 illustrates a process whereby the application gateway on a first computing device polls the second computing device for changes. The process 1000 may be initiated by an application on a first computing device or server such as the application gateway and may be performed over a wired or wireless connection. This process 1000 may be used in replacement of or in combination with the process 800 previously described and may be a polling process wherein the application gateway periodically polls the second computing device for changes either over a wired connection or wireless connection, unlike process 800 where the changes may be automatically transmitted by the second computing device. This may be beneficial in certain instances where second computing devices may not be able to initiate a network connection or operate a communication agent due to constrained resources or lack of wireless data connectivity, amongst other instances. In some cases second computing devices that have the computational resources to perform process 1000 may operate process 1000 instead of or in addition to process 800.

The process 1000 may initially check for the existence of a data connection between the application gateway and the second computing device that may be either a wired or wireless connection. If there is no connection the process 1000 may not continue and may end 1045. Alternatively, the process 1000 may employ a delay block and continue checking for the existence of a data connection.

After a data connection has been detected, a determination 1015 may be made whether the second computing device is associated with the application gateway operating on the first computing device. The second computing device may be associated with the first computing device if the application gateway understands that the second computing device is linked to the first computing device. In one embodiment, the first computing device can store a unique identifier associated with the first computing device on the second computing device, and thereafter use the unique identifier to determine whether the second computing device is to be deemed associated with the host device.

If the determination 1015 is made that the second computing device is associated with the first computing device, the application gateway may analyze the second computing device's database. In one implementation the second computing device's database may be compared with the first computing device's database using a synchronization process. However it may be more efficient for the second computing device's database to mark records that have been modified using the Action Instructions filed shown in FIG. 5. In either case, a determination 1025 may be made whether there are any pending actions to process in the second computing device's database, in which case the actions may be retrieved and processed 1030. The details of the processing of said actions by the application gateway are described in detail above in accordance with previous process 900. The updates may be applied unidirectionally between the second computing device and the first computing device or the application gateway could optionally perform bidirectional synchronization and receive updates or changes from first computing device's data management applications to process on the second computing device. There are several known synchronization methods to accomplish this.

The application gateway may then update the second computing device's database 1035 in a manner similar to that taken 855 in association with the process described above 800. The updates may include clearing the markers as a result of processing the marked actions. Further, if action requests include requests for content to be transferred to the second computing device or if the application gateway performs a bidirectional synchronization 1030 during the database update 1035, the second computing device's database may also be updated to reflect these changes.

The application gateway may then update the second computing device's content store 1040 in a manner similar to that described above 860. In certain cases there may be no updates required to this content store. In other cases, the updates may be as a result of configuration changes made by the user on the second computing device's media management application that requested content to be transferred to or removed from the second computing device. For example, the user may request to transfer to the second computing device the content, for which there were only attributes present on the second computing device, for a photo or a playlist of music. During the synchronization process, the request may be processed by the application gateway and content may be marked for transfer and transferred 1040. Alternatively, a user may request to remove content for certain data items from the second computing device to free up storage space, with the database for the second computing device being marked appropriately by the data management application of the second computing device. During the process 1000, the requests may be processed by the application gateway and content may be marked for deletion and deleted 1040 when the second computing device content store is updated. In this way, the present invention enables management of content from a plurality of data management applications on a second computing device including the transfer and deletion of content for data items regardless of whether or not the content is present on the second computing device.

In yet other cases, the updates may relate to changes made in a first computing device's data management applications. Additions or deletions of content to data collections currently on the device may result in content being marked for transfer or deletion in the second computing device's content store during a bidirectional synchronization process 1030. Any transfers or deletions may be updated 1040 when the second computing device's content store is updated. The process 1000 may then end 1045.

It should be noted that, in one implementation of the present invention, the application gateway can be automatically invoked when a wired or wireless connection is available between the application gateway and the second computing device.

The present invention enables the application gateway 115 or communication agent 340 to determine that the second computing device associated with the application gateway is within proximity of the application gateway. This may be accomplished by determining that both the application gateway and the second computing device are on the same local wireless network either by storing that information or analyzing such information during a request. This may also be accomplished during a Bluetooth pairing or other similar policies that allow proximity to be ascertained. In this way when a user selects content for consumption or transfer, the communication agent may automatically send an action to the application gateway to consume the content on the first computing device. In this way, an intelligent remote control mode can automatically be invoked when a second computing device is within a defined proximity of an associated first computing device.

1. A system for remotely managing one or more data items, each data item including content and attributes, the system comprising:
(a) a first computing device linked to a memory, the first computing device linked to a database including one or more content and one or more attributes related to each content, the first computing device operable to create a structure for referencing the content and/or attributes, the first computing device further operable to provide the structure, content and/or attributes to a second computing device; and
(b) the second computing device linked to a memory, the second computing device operable to receive the structure and a subset of the content and/or attributes from the first computing device, the second computing device operable to enable a user to interact with the structure so as to define one or more instructions to the first computing device for accessing or interacting with the content and/or attributes.

2. The system of claim 1, wherein the second computing device is operable to enable a user to interact with the structure so as to manage content and/or all or a subset of the attributes for each data item.

3. The system of claim 2, wherein the second computing device is operable to enable a user to interact with attributes for content that is not stored on the memory linked to the second computing device.

4. The system of claim 1, wherein the structure is implemented to a database comprising one or more tables.

5. The system of claim 1, wherein the second computing device includes a data management application enabling a user to manage content and/or all or a subset of the attributes.

6. The system of claim 5, wherein the data management application enables a user to create, modify and delete content and attributes.

7. The system of claim 1, wherein the first computing device includes a data management application for creating the structure, the data management application scanning the first computing device for the one or more content, gathering the one or more attributes for each content, optionally creating additional attributes for one or more of the content, and creating the structure for the data items.

8. The system of claim 1, wherein the first computing device includes or is linked to an application gateway and the second computing device includes or is linked to a communication agent, the application gateway and the communication agent operable to communicate with each other to enable the structure, content, attributes and instructions to be provided to the first computing device and the second computing device.

9. A system for remotely managing one or more data items, the system comprising:
(a) a first computing device, the first computing device linked to one or more content and one or more attributes associated with each content, wherein the first computing device is operable to enable modification of the content and/or attributes to define updates;
(b) a second computing device remote from the first computing device, connectable to the first computing device via a network, the second computing device linked to a data structure including at least one of the one or more attributes for each content and referencing each content, the second computing device operable to enable modification of the content and attributes of the data structure to further define updates; and
(c) a communication agent linked to the second computing device, wherein the communication agent is operable to detect a wired or wireless data connection to the first computing device and thereby initiate a transfer between the first computing device and the second computing device corresponding to a synchronization of the updates.

10. The system of claim 9, further comprising an application gateway linked to the first computing device, the application gateway and the communication agent operable to communicate with each other to enable the content, attributes and instructions to be provided to the first computing device and the second computing device.

11. The system as claimed in claim 9, wherein the second computing device is operable to manage the processing of the updates.

12. The system as claimed in claim 9, wherein the first computing device is operable to manage the processing of the updates.

13. A computer-implementable method for remotely managing one or more data items, each data item including content and attributes, the method comprising:
(a) creating, or facilitating the creation, by one or more computer processors of at least a first computing device, a structure for referencing the content and attributes, the first computing device linked to a memory and linked to a database including one or more content and one or more attributes related to each content, the first computing device operable to enable the structure to reference the content and attributes, the first computing device further operable to provide the structure, content, and attributes to a second computing device; and
(b) linking the second computing device to the first computing device by wired or wireless means, the second computing device linked to a memory, the second computing device operable to receive the structure and a subset of the content and/or attributes from the first computing device, the second computing device operable to enable a user to interact with the structure so as to define one or more instructions to the first computing device for accessing or interacting with the content and/or attributes. [(b) is the key step but we say some things about the device and just talk about “linking”—I think step (b) is really enabling interaction with the structure as described . . . please rework in this way . . .

14. The method of claim 13, wherein the second computing device is operable to enable a user to interact with the structure so as to manage content and/or all or a subset of the attributes for each data item.

15. The method of claim 14, wherein the second computing device is operable to enable a user to interact with attributes for content that is not stored on the memory linked to the second computing device.

16. The method of claim 13, wherein the structure is implemented to a database comprising one or more tables.

17. The method of claim 12, wherein the second computing device includes a data management application enabling a user to manage content and/or all or a subset of the attributes.

18. The method of claim 17, wherein the data management application enables a user to create, modify and delete content and attributes.

19. The method of claim 12, wherein the first computing device includes a data management application for creating the structure, the data management application scanning the first computing device for the one or more content, gathering the one or more attributes for each content, optionally creating additional attributes for one or more of the content, and creating the structure for the data items.

20. The method of claim 12, wherein the first computing device includes an application gateway and the second computing device includes a communication agent, the application gateway and the communication agent operable to communicate with each other to enable the structure, content, attributes and instructions to be provided to the first computing device and the second computing device.
